(19) United States
(12) Patent Application Publication
(10) Pub. No.: US 2009/0146509 A1
(43) Pub. Date: Jun. 11, 2009

(54) VIBRATION ACTUATOR

(75) Inventors: Tomohide Aoyagi, Tokyo (JP); Toshio Suzuki, Tokyo (JP)

Correspondence Address: Studebaker & Brackett PC, 1890 Preston White Drive, Suite 105, Reston, VA, 20191, US

(73) Assignee: NAMIKI SEIMITSU HOUSEKI KABUSIKIKAISHA, Adachi-ku, Tokyo (JP)

(21) Appl. No.: 12/065,640

(22) PCT Filed: Sep. 8, 2005
(86) PCT No.: PCT/JP2005/016507

§ 371 Date: May 22, 2008

(51) Int. Cl. H02K 33/18; H02K 33/12

(52) U.S. Cl. 310/15

(57) ABSTRACT

[Object] To provide a vibration actuator capable of obtaining sufficiently sensible vibration with a flat, thin shape maintained.

[Solving Means] Two magnets of a moving part are fixed in a direction where magnetic forces of the magnets are repulsed each other, and the moving part is disposed inside a coil of a fixed part in a housing, so that the moving part collides with the housing when an alternating current is applied to the coil. Therefore, vibration is transferred to the case through the collision. Accordingly, it is possible to implement a miniaturized vibration actuator capable of generating a sufficiently sensible vibration.

### TECHNICAL FIELD

The present invention relates to a vibration linear actuator built in a mobile communication device such as a cellular phone and a portable liquid crystal game machine.

Recently, in a mobile information device such as a cellular phone, a vibration generator is used for notifying a call signal or operating in tune with music. Conventionally, a cylindrical motor with an unbalance weight attached to a shaft thereof is used as an example of the vibration generator. However, the cylindrical motor has a limitation to its miniaturization and a problem in its mounting automation.

In order to overcome the limitation and problem, a coin-type motor with a flat unbalanced weight attached to a shaft thereof has been proposed and practically used. However, in terms of its structure, since the coin-type motor is vibrated in a direction parallel to an attached board, there is a problem in that vibration of the coin-type motor actually mounted and used in an apparatus cannot be easily sensed.

As an approach for solving the problem, a vibration generator is disclosed in Patent Document 1. The vibration generator and a coin-type motor are accommodated in the same space, so that the vibration generator can generate vibration in a direction perpendicular to an attached board.

In addition, as an apparatus for generating vibration in the direction perpendicular to the attached board, a multifunctional vibration actuator having a vibration function, a speaker function, and a buzzer function has been developed (see Patent Document 2).

Patent Document 1: Japanese Patent Application Laid-Open No. 2003-154314

Patent Document 2: Japanese Patent Application Laid-Open No. 10-14194

### DISCLOSURE OF THE INVENTION

### Problems to be Solved by the Invention

However, in the vibration generator disclosed in Patent Document 1, since a moving part is supported by a spring, only the vibration in the vicinity of a natural frequency can be obtained. Therefore, for example, in a case of generating the vibration in tune with music, vibration in the vicinity of a low frequency (10 Hz) cannot be easily obtained. In addition, since an outer yoke as the moving part is formed by punctuating a central portion of a circular disk, an enough weight of the moving part to obtain vibration cannot be easily obtained.

In addition, the multifunctional actuator has a problem in terms of a heat resistance material because it is also used as a sound source for a speaker. Therefore, the vibration generator for notification disclosed in Patent Document 2, which has a flat structure and generates vibration through collision similarly to the present invention, has a problem in that it is difficult to perform a solder reflow process for assembling a board. In addition, since the multifunctional actuator has both functions of sound source and vibration, satisfactory sound and vibration characteristics cannot be simultaneously obtained in a limited thickness size thereof.

For these reasons, an object of the present invention is to provide a vibration generator capable of implementing a construction for reducing production costs by reducing the number of components in comparison with the aforementioned each vibration device by taking in consideration of functions thereof and capable of obtaining sufficiently sensible vibration by driving the vibration generator having a flat, thin structure with a driving method suitable for the construction when the vibration generator is built in a cellular phone or the like.

### Means for Solving the Problems

In order to solve the problems, according to the invention disclosed in Claim 1, there is provided a flat vibration actuator having a moving part including magnets magnetized in a vibration direction, a housing accommodating the moving part, and a fixed part including a coil winding around an axis of the vibration direction to drive the moving part.

According to the invention disclosed in Claim 2, in the flat vibration actuator according to Claim 1, a plate-shaped magnetic member is disposed between the magnets.

According to the invention disclosed in Claim 3, in the flat vibration actuator according to Claim 1, the magnets of the moving part are fastened with respect to a repulsion direction by using a magnet holder for holding edges of the two magnets in a state that the two magnets are in contact with each other.

According to the invention disclosed in Claim 4, in the flat vibration actuator according to Claim 1, the moving part includes one magnet magnetized in the same direction with respect to the vibration direction, and the moving part is disposed inside the fixed part including two coils which are disposed in a direction where magnetic fluxes repulses each other, so that the moving part is vibrated by mutual interaction between a magnetic field generated by the two coils and a magnetic field of the magnet.

According to the invention disclosed in Claim 5, in the flat vibration actuator according to any one of Claims 1 to 4, a magnetic member is provided to an outer side of the fixed part or a case in order to improve efficiency of a magnetic circuit comprising the moving part and the coil(s).

According to the invention disclosed in Claim 6, in the flat vibration actuator according to any one of Claims 1 to 5, a damper is provided to the moving part or the cover in order to absorb an abnormal sound generated from the moving part at the time of driving thereof.

According to the invention disclosed in Claim 7, in the flat vibration actuator according to any one of Claims 1 to 6, an end surface of the moving part has at least one of a rounded R shape, a chamfered shape, and a tapered shape.

According to the invention disclosed in Claim 8, in the flat vibration actuator according to any one of Claims 1 to 7, a shaft extending in the vibration direction penetrates through the moving part to be fixed to the cover, and a shaft bearing is provided between the moving part and the shaft.

According to the invention disclosed in Claim 9, in the flat vibration actuator according to any one of Claims 1 to 8, a gap between the moving part and the fixed part or between the moving part and the housing is adjusted to limit an amount of air flowing through the gap at the time of driving.

### Effects

According to the invention disclosed in Claim 1, unlike the conventional vibration actuators where an elastic member supporting the moving part having a weight transfers vibration to the case, motion of the moving part having the two magnets is directly transferred as vibration through collision to the case, so that strong vibration can be instantaneously obtained in comparison with a vibration actuator using no collision. In addition, since the moving part includes the two magnets, the moving part has a sufficient weight without an additional component such as a weight, so that it is possible to reduce the number of components.

In addition, since the vibration actuator is formed in a flat shape, the vibration direction is perpendicular to the attached board, so that a user carrying a mobile communication apparatus such as a cellular phone can easily sense the vibration when the vibration actuator is actually built in the mobile communication actuator.

According to the invention disclosed in Claim 2, the plate-shaped magnetic member is disposed between the two magnets fastened, the magnetic flux of the magnets can be condensed in a portion facing the vibration direction, so that it is possible to improve the magnetic efficiency at the time of driving thereof.

According to the invention disclosed in Claim 3, the magnets are fastened by using the magnetic holder, so that it is possible to easily assemble the magnets in comparison with a case of using an adhesive.

According to the invention disclosed in Claim 4, the two coils are disposed in a direction where the magnetic fields thereof generated are repulsed each other at the time of applying an alternating current. There is no need for fixing the two magnets that are repulsed each other. In addition, it is possible to easily assemble the two magnets while maintaining the effect of vibration using collision.

According to the invention disclosed in Claim 5, the magnetic member is disposed in an outer side of the case, so that it is possible to prevent magnetic flux from being leaked from the coil(s) and to improve the magnetic efficiency of the magnetic circuit comprising the moving part and the coil(s).

According to the invention disclosed in Claim 6, the damper is disposed to a colliding portion, so that it is possible to prevent destruction of the moving part and occurrence of abnormal sound and to obtain strong vibration.

According to the invention disclosed in Claim 7, it is possible to prevent the moving part from contacting the coils or the like and destruction of the moving part during vibration.

According to the invention disclosed in Claim 8, to the shaft having the shaft bearing maintains the motion of the moving part in a predetermined direction, so that it is possible to obtain a stable vibration without abnormal shaking.

According to the invention disclosed in Claim 9, the gap between the moving part and the case or between the moving part and the coil is adjusted to limit an amount of air flowing through the gap at the time of driving, so that air flow resistance can be used as a damper. Therefore, it is possible to smoothly drive the vibration generator, to decrease a collision sound generated from collision of the moving part to other components, to obtain good vibration characteristic even when being driven within a hermetic housing, and to use a wide frequency band.

### BEST MODE FOR CARRYING-OUT THE INVENTION

Hereinafter, vibration actuators according to embodiments of the present invention will be described with reference to the accompanying drawings.

### First Embodiment

FIG. 1 is a cross-sectional view illustrating a vibration actuator according to a first embodiment of the present invention. The vibration actuator according to the embodiment includes a housing having covers 30 and 31, a moving part having magnets 10 and 11 and dampers 50 and 51, and a coil 20. FIG. 11 is a perspective view illustrating the vibration actuator according to the embodiment. Referring to FIG. 11, the vibration actuator has a circular planar shape. Alternatively, according to a mounting type, an elliptic shape, a circular shape, a polygonal shape, and the like can be selectively used as the planar shape.

In the vibration actuator according to the embodiment, the moving part is driven by applying an alternating current to the coil 20. Referring to FIG. 10, the magnets 10 and 11 are fastened in a direction where the magnetic poles are repulsed each other. Therefore, when the alternating current is applied to the coil 20, an attractive force and a repulsive force are exerted to upper and lower ends of the moving part due to a magnetic force generated by the coil 20 and a magnetic force of the moving part. Therefore, the moving part alternately collides with walls of the covers 30 and 31 facing the dampers 50 and 51, so that vibration is transmitted.

In the embodiment, the dampers 50 and 51 may be omitted. Corners of the magnets 10 and 11 may be provided with a rounded portion R, a chamfered portion, or a tapered portion. Accordingly, it prevents the moving part from contacting with the wall surface of the cover 30 which is back to back the coil, and prevents the moving part from interfering vibration.

In addition, in terms of the same technical idea, as shown in FIG. 2, in order to improve the magnetic efficiency of a magnetic circuit including the coil and the moving part, a yoke 60 comprising a plate-shaped magnetic member is disposed between the magnets 10 and 11. In addition, as shown in FIG. 3, the magnets 10 and 11 may be fastened by using a magnetic holder 40. On the other hand, in FIGS. 1 to 3, instead of the rounded portion R, a chamfered portion or a tapered portion may be provided, or the magnets may be used in an unprocessed state. The dampers 50 and 51 may be attached to the covers 30 and 31 instead of the magnets 11 and 12, as shown in FIG. 3.

In addition, in the embodiment, a gap between the moving part and the wall surface of the cover 30 which is back to back the coil is adjusted to limit an amount of air flow at the time of vibration, so that a stable vibration can be obtained.

In the embodiment, since the vibration is directly transmitted by the collision, strong vibration can be obtained in comparison with a conventional vibration actuator to which a sinusoidal wave is applied.

### Second Embodiment

FIG. 4 is a cross-sectional view illustrating a vibration actuator according to a second embodiment of the present invention. The vibration actuator according to the embodiment includes a moving part including magnets 10 and 11, dampers 50 and 51, and a shaft bearing 80, a fixed part including a case 90, covers 32 and 33, and a coil 20, and a shaft 70 which penetrates through the moving part to be fastened to the covers.

In the embodiment, the shaft bearing 80 is provided to the moving part, and the shaft 70 penetrates through the shaft bearing 80 of the moving part to be fastened to the covers 32 and 33, so that a uniform gap between the coil 20 and the moving part is maintained. Accordingly, stable vibration can be obtained. In addition, since the uniform gap between the coil 20 and the moving part is maintained, an amount of air flow can be limited. Therefore, the air is used as a damper, so that a stable vibration can be obtained.

In addition, the corners of the moving part are provided with a rounded portion R, so that the moving part can be easily inserted into the case 90 without destruction of the coil 20.

In the embodiment, on the basis of the same technical point of view, as shown in FIG. 5, a yoke 60 comprising a plate-shaped magnetic member is disposed between the magnets 10 and 11. In addition, as shown in FIG. 6, the magnets 10 and 11 may be fastened by using a magnetic holder 40.

In FIGS. 4 to 6, instead of the rounded portion A, a chamfered portion may be provided, or the magnets may be used in an unprocessed state. The dampers 50 and 51 may be attached to the covers 32 and 33 instead of the magnets 11 and 12, as shown in FIG. 6.

### Third Embodiment

FIG. 7 is a cross-sectional view illustrating a vibration actuator according to a third embodiment of the present invention. In the vibration actuator according to the embodiment, a moving part includes a magnet 12 and dampers 50 and 51, and a fixed part includes covers 30 and 31 and coils 21 and 22. In the embodiment, the coils 21 and 22 not the magnet 12 are disposed in a direction where the magnetic fields generated from the coils 21 and 22 are repulsed each other when the alternating current is applied. Accordingly, the moving part can be vibrated similarly to the first embodiment.

In addition, in the embodiment, the corners of the magnet 12 are provided with a rounded portion R. Accordingly, during the vibration of the moving part, the moving part cannot be in contact with the wall surface of the cover 30 where the coils 20 and 21 are provided in a rear side thereof which is back to back the coils 21 and 22, so that the vibration of the moving part cannot be interfered. The rounding process of the portion R may be substituted with a chamfering process or a tapering process. Although the process may not be performed, substantially the same effect can be obtained. However, as described above, in order to obtain a stable vibration of the moving part, the process is preferably performed. In addition, similar to the process of the portion R, the vibration actuator can be driven in the state that the dampers 50 and 51 are removed.

In addition, an amount of air flow at the time of driving is limited by adjusting a gap between the moving part and the wall surface of the cover 30 which is back to back the coil, so that a stable vibration can be obtained.

### Fourth Embodiment

FIG. 8 is a cross-sectional view illustrating a vibration actuator according to a fourth embodiment of the present invention. As seen in the cross-sectional view of FIG. 8, the vibration actuator according to the embodiment is constructed by providing the shaft 70 and the shaft bearing 80 to the vibration actuator according to the third embodiment, so that abnormal shaking can be prevented at the time of vibration thereof. Similarly to FIG. 7, in the embodiment, the vibration actuator can be driven in the construction where the dampers 50 and 51 are removed.

In the embodiment, instead of the rounding process of the portion R provided to the magnet 12, a chamfering process or a tapering process may be performed to the magnet 12, or the magnet may be driven in an unprocessed state. However, the magnet provided with the processed portion is preferred in that the moving part can be easily inserted into the cover 30 at the time of assembling thereof.

In the embodiment, the gap between the moving part and the wall surface of the cover 30 which is back to back the coil can be adjusted by using the shaft. Accordingly, the amount of air flow is limited, so that the air is used as a damper. Accordingly, a stable vibration can be obtained.

As shown in FIG. 9, in order to improve the magnetic efficiency of the magnetic circuit including the moving part and the coil, a magnetic member 110 may be provided to an outer circumference of each vibration actuator 100 according to the first to fourth embodiments. FIG. 9 illustrates a circular disk as an example of a shape of the vibration actuator according to the first to fourth embodiments. However, the present invention is not particularly limited to the shape in manufacturing an actual product.

According to the first to fourth embodiments of the present invention, it is possible to implement a vibration actuator capable of reducing costs, being easily assembled, and generating sufficiently sensible vibration with a thin structure maintained.

### BRIEF DESCRIPTION OF THE DRAWINGS

FIG. 1 is a cross-sectional view illustrating a vibration actuator according to a first embodiment of the present invention.

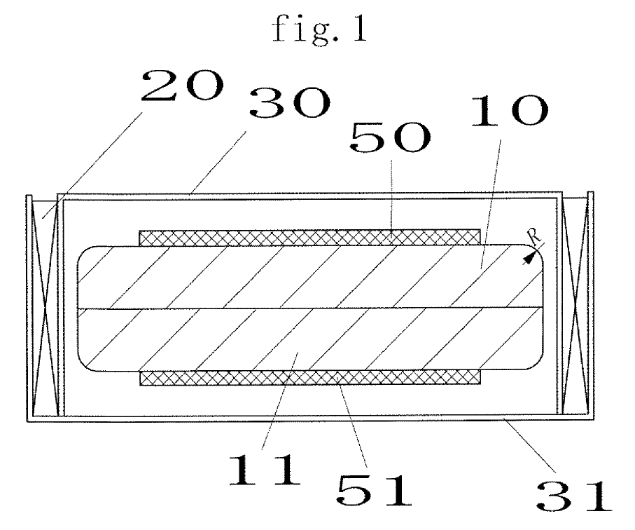

FIG. 2 is a cross-sectional view illustrating a state that a yoke is inserted between two magnets of the vibration actuator according to the first embodiment.

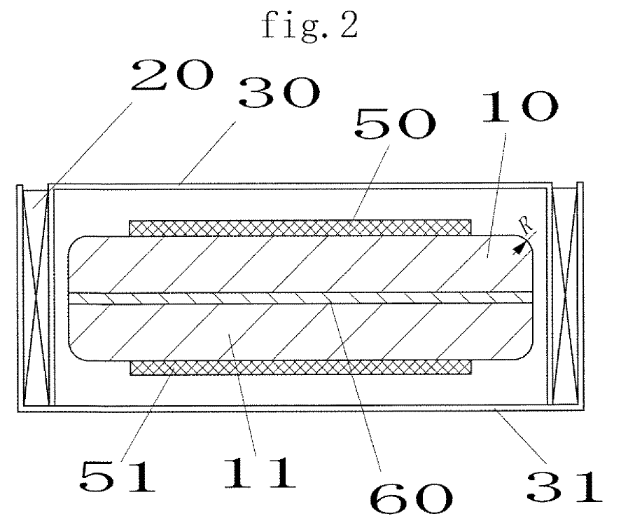

FIG. 3 is a cross-sectional view illustrating a state that magnets are fastened by a magnet holder in the vibration actuator according to the first embodiment.

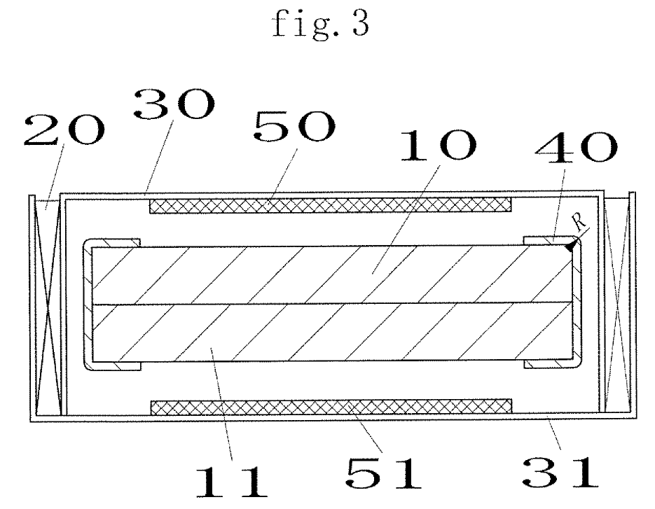

FIG. 4 is a cross-sectional view illustrating a vibration actuator according to a second embodiment of the present invention.

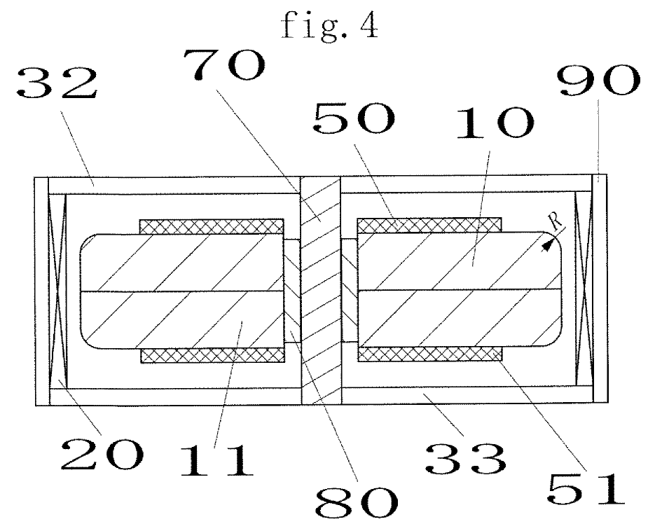

FIG. 5 is a cross-sectional view illustrating a state that a yoke is inserted between two magnets of the vibration actuator according to the second embodiment.

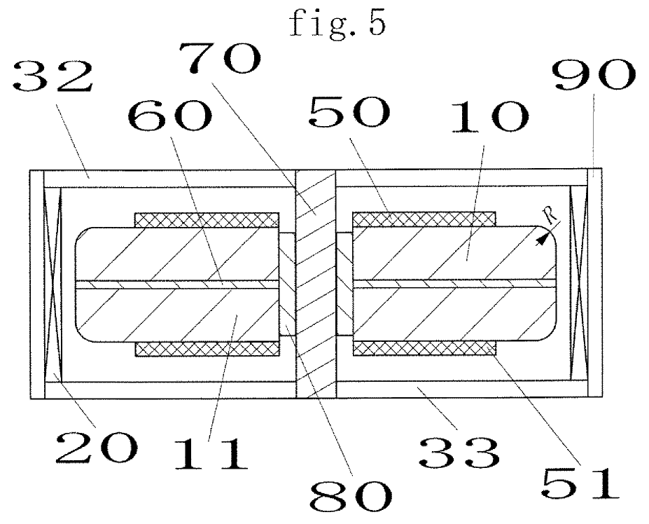

FIG. 6 is a cross-sectional view illustrating a state that two magnets are fastened by a magnet holder in the vibration actuator according to the first embodiment.

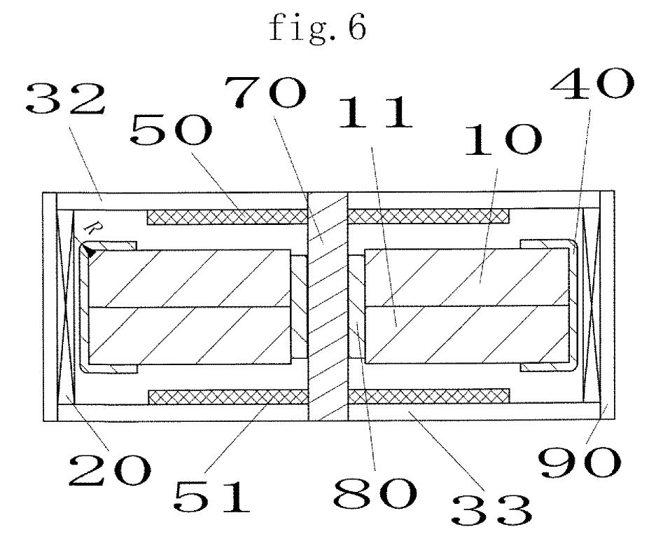

FIG. 7 is a cross-sectional view illustrating a vibration actuator according to a third embodiment of the present invention.

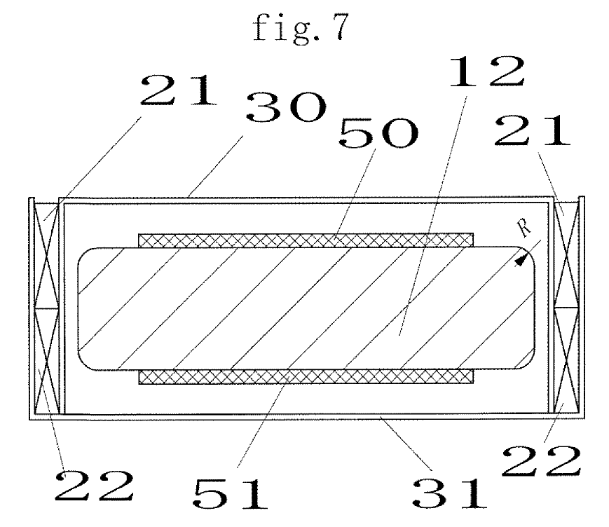

FIG. 8 is a cross-sectional view illustrating a vibration actuator according to a fourth embodiment of the present invention.

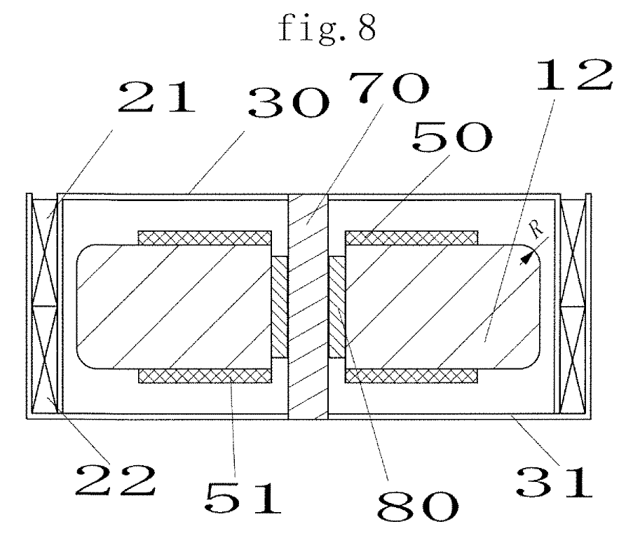

FIG. 9 is a layout illustrating a state that a magnetic member is provided in an outer side to improve magnetic efficiency in vibration actuator according to the first to fourth embodiments.

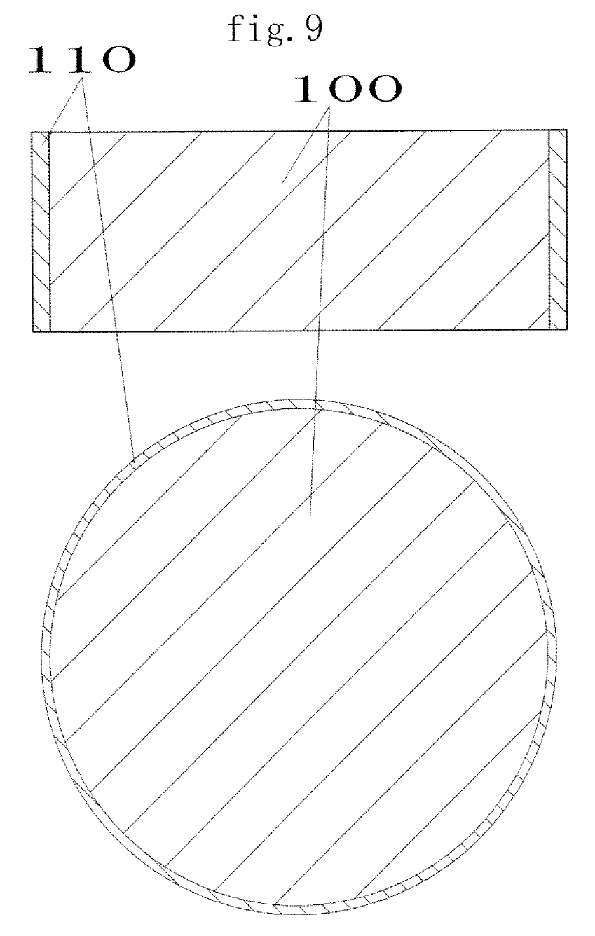

FIG. 10 is a view for explaining a basic driving direction of vibration actuators according to the embodiments.

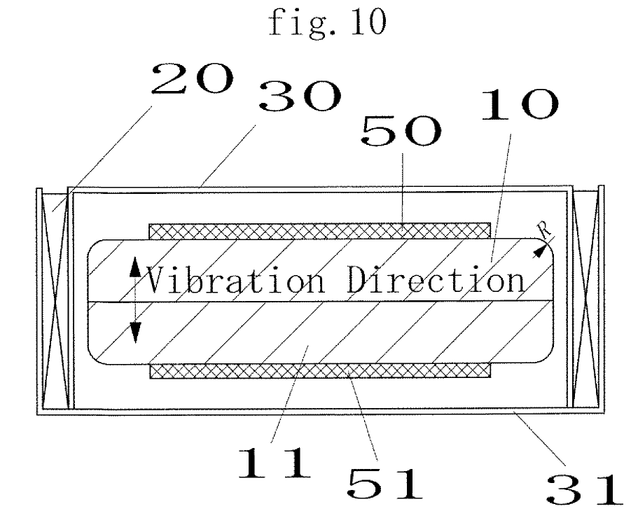

FIG. 11 is a perspective view illustrating parts of the vibration actuator having a circular planar shape of FIG. 1, according to the first embodiment.

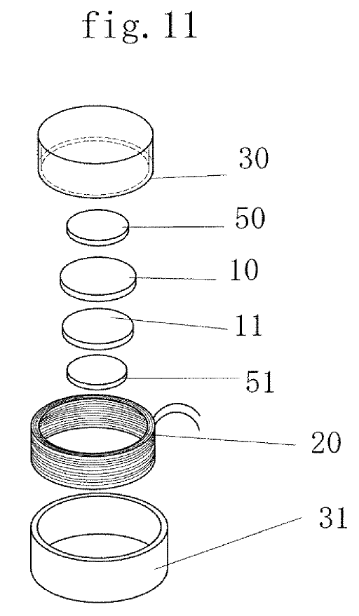

### REFERENCE NUMERALS

10, 11, 12: magnet
20, 21, 22: coil
30, 31, 32, 33: cover
40: magnet holder
50, 51: damper
60: yoke
70: shaft
80: shaft bearing
90: case
100: vibration actuator
110: magnetic member

1-9. (canceled)

10. A flat vibration actuator having a moving part including at least two magnets magnetized in a vibration direction, a housing including a case accommodating the moving part and a cover covering an opening of the case, and a fixed part including a coil winding around an axis of the vibration direction to drive the moving part,
wherein the two magnets of the moving part are fixed in a direction where magnetic forces of the magnets repulse each other, and the moving part is disposed inside the coil of the fixed part in the housing, so that the moving part collides with the cover to transfer vibration when an alternating current is applied to the coil.

11. The flat vibration actuator according to claim 10, wherein a plate-shaped magnetic member is disposed between the magnets.

12. The flat vibration actuator according to claim 10, wherein the two magnets are fastened by using a magnet holder for holding edges of the two magnets.

13. A flat vibration actuator having a moving part including one magnet magnetized in a vibration direction, a housing including a case accommodating the moving part and a cover, and a fixed part including at least two coils winding around an axis of the vibration direction to drive the moving part,
wherein the two coils of the fixed part are disposed in a direction where magnetic fluxes generated at the time of applying an alternating current repulse each other with respect to the vibration direction of the moving part, so that the moving part is vibrated by mutual interaction between a magnetic field generated by the two coils and a magnetic field of the magnet.

14. The flat vibration actuator according to claim 13, wherein a magnetic member is provided to an outer side of the case.

15. The flat vibration actuator according to claim 13, wherein a damper is provided to the moving part or the cover.

16. The flat vibration actuator according to claim 13, wherein an end surface of the moving part has at least one of a rounded R shape, a chamfered shape, and a tapered shape.

17. The flat vibration actuator according to claim 13,
wherein a shaft extending in the vibration direction penetrates through the moving part to be disposed to the cover, and
wherein a shaft bearing is provided between the moving part and the shaft.

18. The flat vibration actuator according to claim 13, wherein a gap between the moving part and the fixed part or between the moving part and the housing is adjusted to limit an amount of air flowing through the gap at the time of driving.

19. The flat vibration actuator according to claim 10, wherein a magnetic member is provided to an outer side of the case.

20. The flat vibration actuator according to claim 10, wherein a damper is provided to the moving part or the cover.

21. The flat vibration actuator according to claim 10, wherein an end surface of the moving part has at least one of a rounded R shape, a chamfered shape, and a tapered shape.

22. The flat vibration actuator according to claim 10,
wherein a shaft extending in the vibration direction penetrates through the moving part to be disposed to the cover, and
wherein a shaft bearing is provided between the moving part and the shaft.

23. The flat vibration actuator according to claim 10, wherein a gap between the moving part and the fixed part or between the moving part and the housing is adjusted to limit an amount of air flowing through the gap at the time of driving.
